(19) United States
(12) Patent Application Publication
(10) Pub. No.: US 2009/0213798 A1
(43) Pub. Date: Aug. 27, 2009

(54) METHOD, SYSTEM, MOBILE NODE, COMMUNICATION NODE AND HOME AGENT FOR COMMUNICATION IN MOBILE IPV6 NETWORKS

(75) Inventor: Chunqiang Li, Shenzhen (CN)

Correspondence Address: Huawei Technologies Co., Ltd.;c/o Darby & Darby P.C., P.O. Box 770, Church Street Station, New York, NY, 10008-0770, US

(73) Assignee: Huawei Technologies Co., Ltd., Shenzhen (CN)

(21) Appl. No.: 12/395,291

(22) Filed: Feb. 27, 2009

Related U.S. Application Data
(63) Continuation of application No. PCT/CN2007/070359, filed on Jul. 26, 2007.

(30) Foreign Application Priority Data
Aug. 31, 2006 (CN) 200610111878.8

(51) Int. Cl. H04W 88/02

(52) U.S. Cl. 370/328

(57) ABSTRACT

A method for communication in IPv6 networks is provided. In this method, first, a destination node in communication is notified about an association relation between a home address (HoA) index and an HoA. Then, in a packet, an HoA option and a Type-2 routing header are substituted by an HoA index option or a binding index extension header carrying the HoA index according to the association relation stored in the destination node. Further, a system corresponding to the above method is also provided. Through the present invention, an overhead of a mobile IPv6 packet is effectively reduced. Besides, the HoA index is simple in content and is not relevant to any privacy parameter in content, thus ensuring the security of communication.

The present application is a continuation of International Patent Application No. PCT/CN2007/070359, filed Jul. 26, 2007, which claims the benefit of Chinese Patent Application No. 200610111878.8, filed on Aug. 31, 2006, both of which are hereby incorporated by reference in their entireties.

### BACKGROUND OF THE INVENTION

1. Field of the Technology

The present invention relates to field of network communication technology, and more particularly to a method, system, mobile node, communication node, and home agent for communication in mobile Internet Protocol version 6 (IPv6) networks.

2. Background of the Invention

Mobile IPv6 is a mobility solution at the network layer. The mobile IPv6 has three basic network entities: a mobile node (MN), a communication node (CN), and a home agent (HA).

An MN is uniquely identified with a home address (HoA). When the MN roams to a foreign network, a care of address (CoA) is generated in a certain manner. The mobile IPv6 specifies that, when the MN moves from one link to another, the communication thereof using the HoA is not interrupted, and the mobility of the node is transparent to a transport layer and other upper-layer protocols. The mobile IPv6 defines two different modes to solve the mobility problem, i.e., a bi-directional tunnel mode and a route optimization mode.

In the bi-directional tunnel mode, the MN notifies the HA about the CoA thereof through a binding update (BU) message. Thus, the HA captures a packet sent to a home network of the MN for communicating with the MN, and forwards the packet to the MN via the tunnel mode. When the MN sends a packet to the CN, it needs to send the packet to the HA through the tunnel mode, and then the HA decapsulates and forwards the tunnel packet to the CN.

In the route optimization mode, the MN needs to be registered to the CN. First, a return routability procedure (RRP) is performed. If the RRP is successfully performed, the MN is enabled to binding update the CoA and the HoA to a binding cache list of the CN via a BU message, and directly transmit packets with the CN in the subsequent communication process, instead of forwarding packets through the HA.

In both the above two modes, a destination option extension header and a Type-2 routing header are used for packet transmission between the MN and the CN. The mobile IPv6 further adds an option to the IPv6 destination option extension header: HoA option. This option is configured to notify an opposite party of the HoA of the MN by sending a datagram when the MN is in a foreign link. On the contrary, when the MN is in a foreign link and the CN sends a datagram to the MN, the mobile IPv6 adopts the Type-2 routing header to carry the HoA in the packet of the datagram, and the IPv6 destination field includes the CoA of the MN. In the bi-directional tunnel mode, the HA adds the destination option extension header and terminates the Type-2 routing header during the packet forwarding. In the route optimization mode, the MN and the CN respectively perform the above processing of extension header.

As the IPv6 has an address of 128 bits, the overhead of the packet header is greatly increased due to the HoA option or the Type-2 routing header included therein, so that a payload rate of data transmission by the mobile subscriber at a foreign link is lowered.

In another aspect, when the mobile IPv6 is used for communication, the privacy of the location is very important. Without any concealment, the sensitive data of the subscriber may be collected and analyzed, so that the activity of the subscriber may be detected and tracked, thereby seriously threatening the security of the mobile subscriber. When an MN is in a foreign link, as the HoA option in the sending packet and the Type-2 routing header in the receiving packet both contain the HoA of the MN, the packet may be easily intercepted and tracked by an eavesdropper. In order to prevent exposing an HoA of an MN located at a foreign link to the eavesdropper, currently, a surrogate home address (SHoA) is employed to substitute the real HoA. However, the above solution has the following disadvantages. As the SHoA has the same length as the HoA, the overhead of the header is still rather large. Meanwhile, as being limited by the generation conditions for the SHoA, a lot of information is correlated, and thus it is difficult to achieve complete privacy.

### SUMMARY OF THE INVENTION

Accordingly, the present invention is directed to a method and a system for communication in mobile IPv6 networks, so as to reduce an overhead of a header of a mobile IPv6 packet and meanwhile enhance the address privacy.

In order to achieve the above objective of the present invention, the following technical solutions are provided. The present invention provides a method for communication in mobile IPv6 networks, which includes notifying a destination node in communication of an association relation between a home address (HoA) and an HoA index of a mobile node (MN); carrying the HoA index in an interactive packet between the MN and the destination node, while removing the HoA from the packet; and obtaining the HoA through the HoA index by the MN or the destination node as a packet receiving end.

The present invention further provides an MN in a system for communication in mobile IPv6 networks, which includes: an index association module, adapted to notify a destination node in communication of an association relation between an HoA and an HoA index of the MN; and a first packet sending module, adapted to send a packet to the destination node. In addition, when the MN is in a foreign link, the first packet sending module carries the HoA index corresponding to the HoA of the MN in the packet to be sent, and removes the HoA from the packet to be sent.

The present invention further provides a CN in a system for communication in mobile IPv6 networks, which includes: a first association storage module, adapted to receive and store an association relation between an HoA and an HoA index notified by an MN; and a second packet sending module, adapted to send a packet. In addition, when sending a packet to the MN in a foreign link, the second packet sending module carries the HoA index corresponding to the HoA of the MN in the packet, and removes the HoA from the packet.

The present invention further provides an HA in a system for communication in mobile IPv6 networks, which includes: a second association storage module, adapted to store an association relation between an HoA and an HoA index notified by an MN; and a third packet processing module, adapted to receive a packet carrying the HoA index and obtain the HoA corresponding to the HoA index.

The present invention further provides a system for communication in mobile IPv6 networks, which includes an MN, a CN, and an HA.

The MN is adapted to notify the CN and the HA of an association relation between an HoA and an HoA index, carry the HoA index corresponding to the HoA in a packet to be sent when the MN is in a foreign link, and remove the HoA from the packet.

The CN is adapted to receive and store the association relation between the HoA and the HoA index of the MN, carry the HoA index corresponding to the HoA of the MN in a packet when sending the packet to the MN in a foreign link, and remove the HoA from the packet.

The HA is adapted to receive and store the association relation between the HoA and the HoA index of the MN, receive the packet carrying the HoA index, and obtain the corresponding HoA according to the HoA index.

In the embodiments of the present invention, the HoA index and the HoA are bound, and the HoA index is adopted to substitute the HoA in a communication packet. As the HoA index is generally a simple pointer, the occupied space of the header is greatly reduced. Meanwhile, the HoA index is quite simple in content and is not relevant to any privacy parameter in content, thus ensuring the security of communication. Furthermore, even if a plurality of HoAs of the MN is bound to the same CoA, it does not cause any confusion.

### BRIEF DESCRIPTION OF THE DRAWINGS

The present invention is described in detail as follows by reference to the accompanying embodiments and drawings, among which:

FIG. 1 is a schematic flow chart of a method for communication in mobile IPv6 networks according to a first embodiment of the present invention;

FIG. 2 is a schematic flow chart of a method for communication in mobile IPv6 networks according to a second embodiment of the present invention;

FIG. 3 is a schematic view of a format of a binding index extension header according to the second embodiment of the present invention;

FIG. 4 is a schematic flow chart of a method for communication in mobile IPv6 networks according to a third embodiment of the present invention;

FIG. 5 is a schematic view of a format of a binding index extension header according to the third embodiment of the present invention; and

FIG. 6 is a schematic view of a structure of a system for communication in mobile IPv6 networks according to a fourth embodiment of the present invention.

### DETAILED DESCRIPTION OF THE EMBODIMENTS

A method for communication in mobile IPv6 networks is provided. In this method, first, a corresponding communication node (CN) is notified about an association relation between a home address (HoA) index and an HoA. Then, in a datagram, an HoA option and a Type-2 routing header are substituted by an HoA index option or a binding index extension header carrying the HoA index according to the above association relation stored in a cache entry of the CN. In addition, the association relation between the HoA index and the HoA may be notified through a binding update (BU) process. Furthermore, a system corresponding to the above method is also provided. The communication method and system of the present invention will be illustrated in detail below.

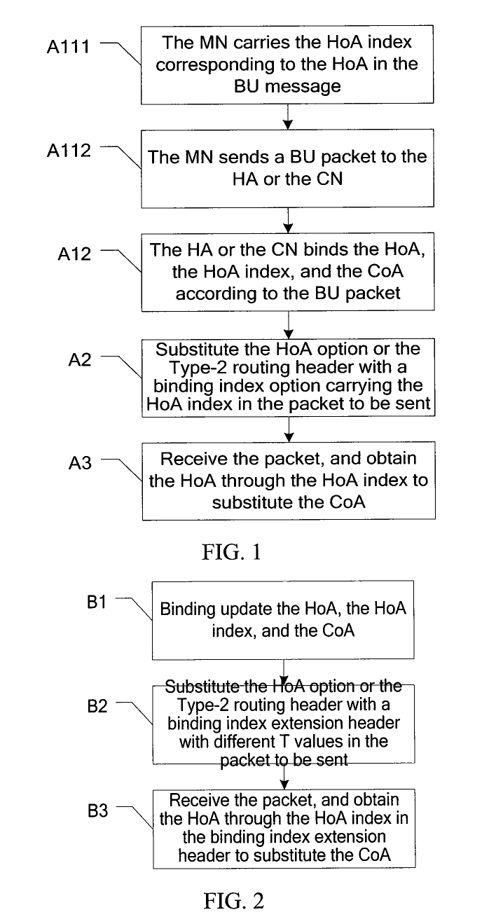

In a first embodiment, a method for communication in mobile IPv6 networks is provided. Referring to FIG. 1, the method includes the following steps.

In Step A1, an HA and/or a CN is notified about an association relation between an HoA and an HoA index of an MN. In this embodiment, the association relation is notified through a BU process, which further includes the following steps.

In Step A11, the MN sends a BU message to the HA or the CN.

In Step A111, the BU message includes the HoA and the HoA index respectively corresponding to the HoA.

The HoA index is uniquely corresponding to the HoA provided by the MN one by one. When an MN has one or more HoAs, an HoA list is stored in a cache of the MN in a form of an array, a link list, or another manner. Each of the n HoAs (n>=1) of the MN may establish a mapping relation with a set of numbers of 0 to (n-1) (or 1 to n). For example, the numbers of 0 to (n-1) (or 1 to n) may be array subscripts of the HoA list stored in arrays or storage location marks of the HoAs. Therefore, the array subscripts of the HoA list of the MN may serve as the corresponding HoA indexes, so that the HoA of the MN may be directly obtained through the corresponding HoA index.

In Step A112, a BU packet is sent.

In the BU packet, as for the IPv6 header, a source address is the CoA, and a destination address is the CN or the HA, which are respectively corresponding to the BU of the CN or the HA; a destination option extension header carries the HoA option for placing the HoA or an SHoA thereof; and a mobility header is the BU message with options including a serial number, a home temporary random number index, a care-of temporary random number index, the HoA index, a message license code, and the like.

In Step A12, upon receiving the BU message, the HA or the CN performs binding update according to the BU message, so as to bind the HoA, the HoA index, and the CoA. Generally, the HA or the CN returns a binding acknowledge (BA) message for indicating the completion of the BU process to the MN. After that, the packet transmission is carried out between the nodes according to the updated binding cache entry.

Definitely, in order to store the HoA index, a field for storing the HoA index needs to be added in the binding cache entry of the MN, HA, or CN.

The above BU method is applicable to the BU process between the MN and the HA, and is also applicable to the BU process between the MN and the CN. However, before sending the BU message from the MN to the CN, a return routability procedure (RRP) needs to be performed. This procedure may be carried out according to the prior art, so the details will not be described herein again.

Definitely, in addition to the aforementioned manner of performing the binding update through sending a BU packet, other notification modes can also be employed to notify the association relation between the HoA and the HoA index. For example, a Home Test Init (HoTI) message in the RRP process may be used to carry the notification information. Any solution is feasible, as long as it can notify the communication node of the association relation.

In Step A2, a binding index option is added to the mobility header for carrying the HoA index, the HoA option or the Type-2 routing header is removed from the packet, and then the packet is sent. The packet may be sent in the following two manners.

1. When the MN in a foreign link sends a packet to the CN or the HA, the HoA option carried in the destination option extension header is removed from the packet, and a binding index option is set in the mobility header of the packet for carrying the HoA index corresponding to the HoA of the MN.

2. When the CN sends a packet to the MN in a foreign link, the Type-2 routing header is removed from the packet, and a binding index option is set in the mobility header of the packet for carrying the HoA index corresponding to the HoA of the MN.

In Step A3, the packet carrying the binding index option is received, and the HoA corresponding to the HoA index is obtained to substitute the CoA in the packet. There are two receiving circumstances corresponding to the two sending circumstances in Step A2.

1. After the CN or the HA receives the packet carrying the binding index option sent from the MN, the binding entry is searched for according to the CoA of the MN in the packet, and then the HoA corresponding to the HoA index in the binding index option is obtained to substitute the CoA in the packet.

2. After the MN receives the packet carrying the binding index option, the HoA corresponding to the HoA index in the binding index option is obtained to substitute the CoA in the packet.

As seen from the above, considering the processing of the binding index option, the MN is slightly different from the CN or the HA due to the following reasons. As for the MN, the HoA index carried by the binding index option is uniquely corresponding to the HoA, and thus there is no need to refer to other parameters. As for the CN or the HA, the HoA index is only a simple pointer, so that a corresponding binding entry should be first determined according to the CoA, and then the corresponding HoA is obtained through the HoA index.

The HoA index is only a very short pointer value, whereas the HoA or the SHoA carried in the HoA option or the Type-2 routing header has a length of 128 bits. Therefore, the header length can be greatly reduced. Besides, as the HoA index is the only parameter corresponding to the HoA in the packet, the communication security is further enhanced. Of course, the “binding index extension header” may not be used, and instead, a “binding index option” is added to the mobility header for carrying the HoA index.

In a second embodiment, a method for communication in mobile IPv6 networks is also provided. Referring to FIG. 2, the method of this embodiment is substantially the same as that of the first embodiment, but the difference there-between lies in that, in this embodiment, a binding index extension header is adopted to carry an HoA index. The method includes the following steps.

In Step B1, a BU process is performed to binding update the association relation among the HoA, the HoA index, and the CoA to a binding cache entry of a communication node required for communication. This step may be carried out according to Step A1 in the first embodiment.

In Step B2, a binding index extension header is added to the IPv6 header for carrying the HoA index, the HoA option or the Type-2 routing header is removed from the packet, and then the packet is sent.

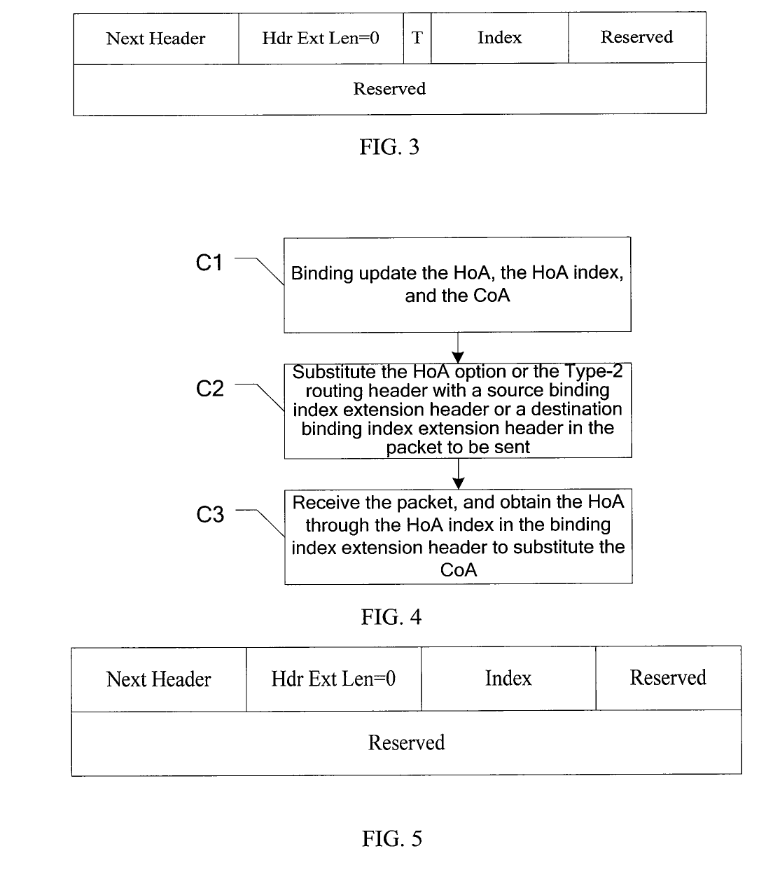

In this embodiment, the binding index extension header may adopt a format shown in FIG. 3. This extension header is defined according to a common format of an extension header in the IPv6. Referring to FIG. 3, the field of “Next Header” indicates the next extension header, the field of “Hdr Ext Len” indicates a length of this extension header, the field of “T” indicates a type, which occupies one bit, and the field of “Index” carries the HoA index value, which occupies 7 bits. In the field of “T”, 0 or 1 is adopted to indicate whether the HoA corresponding to the HoA index carried by the extension header substitutes the source address or the destination address in the packet. Furthermore, in the field of “Index”, if the length of the HoA index value exceeds 7 bits, the space of the following “Reserved” part can also be used.

The following two sending circumstances are provided according to different sets of the T field in the binding index extension header.

1. When the MN in a foreign link sends a packet to the CN or the HA, the HoA option carried in the destination option extension header is removed from the packet, and a binding index extension header is added to the IPv6 header of the packet for carrying the HoA index corresponding to the HoA of the MN. At this time, the T in the binding index extension header is set as 0 (or 1, as long as different conditions are distinguished by different values), and the Index carries the HoA index value.

2. When the CN sends a packet to the MN in a foreign link, the Type-2 routing header is removed from the packet, and a binding index extension header is added to the IPv6 header of the packet for carrying the HoA index corresponding to the HoA of the MN. At this time, the T in the binding index extension header is set as 1.

In Step B3, the packet carrying the binding index extension header is received, and the HoA corresponding to the HoA index is obtained to substitute the CoA in the packet. Similarly, two receiving circumstances are provided according to different sets of the T field in the binding index extension header.

1. After the CN or the HA receives the packet carrying the binding index extension header from the MN, it is determined that the T is set as 0, a binding entry is searched for according to the CoA of the MN in the packet, and then the HoA corresponding to the Index value in the binding index extension header is obtained to substitute the source address CoA in the packet.

2. After the MN receives the packet carrying the binding index extension header, it is determined that the T is set as 1, and then the HoA corresponding to the Index value in the binding index extension header is obtained to substitute the destination address CoA in the packet.

In this embodiment, a binding index extension header is added to carry the HoA index, and thus no binding index option needs to be set in the mobility header. Furthermore, as the requirement of the mobility header about byte alignment may cause a large overhead, the method of this embodiment effectively reduces the overhead of the header.

In a third embodiment, a method for communication in mobile IPv6 networks is also provided. Referring to FIG. 4, the method of this embodiment is substantially the same as that of the second embodiment, but the difference there-between lies in that, in this embodiment, two binding index extension headers are adopted to carry the HoA index. The method includes the following steps.

In Step C1, a BU process is performed to binding update the association relation among the HoA, the HoA index, and the CoA to a binding cache entry of a communication node required for communication. This step may be carried out according to Step A1 in the first embodiment.

In Step C2, two binding index extension headers, i.e., a source binding index extension header and a destination binding index extension header, are added to the IPv6 header for carrying the HoA index, the HoA option or the Type-2 routing header is removed from the packet, and then, the packet is sent.

In this embodiment, the two binding index extension headers both adopt a format shown in FIG. 5. The source binding index extension header and the destination binding index extension header are distinguished from each other by the next header indicator of the previous header in the same packet. In the format of the two extension headers, the field of “Next Header” indicates the next extension header, the field of “Hdr Ext Len” indicates a length of this extension header, and the field of “Index” carries the HoA index value, which occupies 8 bits. Furthermore, if the length of the Index exceeds 8 bits, the bits of the following “Reserved” part can be used.

The following two sending circumstances are provided according to different binding index extension headers.

1. When the MN in a foreign link sends a packet to the CN or the HA, the HoA option carried in the destination option extension header is removed from the packet, and a source binding index extension header is added to the IPv6 header of the packet for carrying the HoA index corresponding to the HoA of the MN. At this time, the HoA index value is placed in the Index field of the source binding index extension header.

2. When the CN sends a packet to the MN in a foreign link, the Type-2 routing header is removed from the packet, and a destination binding index extension header is added to the IPv6 header of the packet for carrying the HoA index corresponding to the HoA of the MN. At this time, the HoA index value is placed in the Index field of the destination binding index extension header.

In Step C3, the packet carrying the source/destination binding index extension header is received, and the HoA corresponding to the HoA index is obtained to substitute the CoA in the packet. Similarly, two receiving circumstances are provided according to different binding index extension headers.

1. After the CN or the HA receives the packet carrying the source binding index extension header sent from the MN, a binding entry is searched for according to the CoA of the MN in the packet, and then, the HoA corresponding to the Index value is obtained to substitute the source address CoA in the packet.

2. After the MN receives the packet carrying the destination binding index extension header, the HoA corresponding to the Index value is obtained to substitute the destination address CoA in the packet.

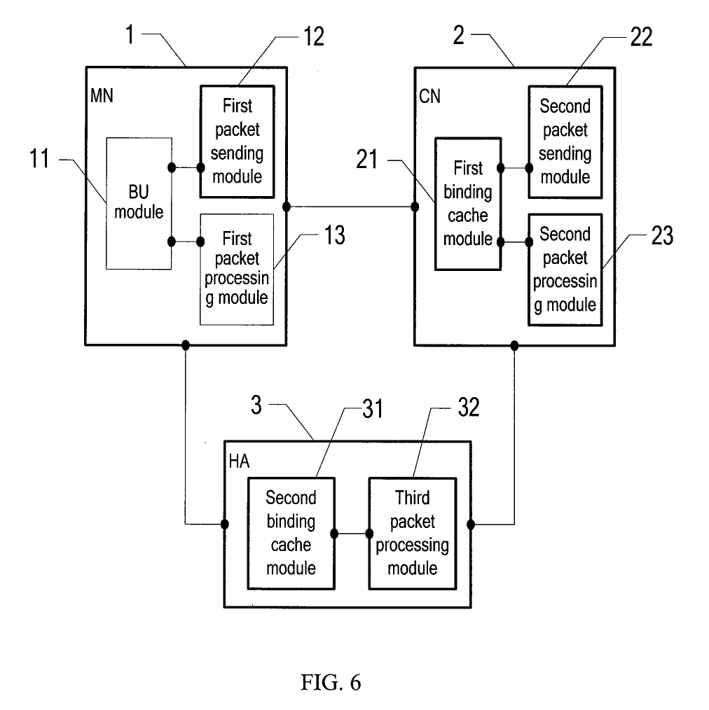

In a fourth embodiment, a system for communication in mobile IPv6 networks is provided. Referring to FIG. 6, the system includes an MN 1, a CN 2, and an HA 3.

The MN 1 includes a BU module 11 serving as an index association module, a first packet sending module 12, and a first packet processing module 13.

The BU module 11 is adapted to send a BU message containing an HoA and an HoA index corresponding to the HoA to the HA 3 and/or the CN 2, so as to notify the HA 3 and/or the CN 2 of an association relation between the HoA and the HoA index of the MN 1.

The first packet sending module 12 is adapted to remove an HoA option from a packet when the MN 1 in a foreign link sends the packet to the CN 2 or the HA 3, and then set a binding index option carrying the HoA index corresponding to the HoA of the MN 1 in a mobility header of the packet according to the association relation in the BU module 11.

The first packet processing module 13 is adapted to receive the packet carrying the binding index option sent from the CN 2, and obtain the HoA corresponding to the HoA index in the binding index option to substitute a CoA in the packet.

The CN 2 includes a first binding cache module 21, a second packet sending module 22, and a second packet processing module 23.

The first binding cache module 21 is adapted to perform binding update according to the BU message sent from the MN 1, so as to bind the HoA, the HoA index, and the CoA, and thus store the association relation between the HoA and the HoA index notified by the MN 1.

The second packet sending module 22 is adapted to remove a Type-2 routing header from a packet when the CN 2 sends the packet to the MN 1 in a foreign link, and then set a binding index option carrying the HoA index corresponding to the HoA of the MN 1 in a mobility header of the packet according to the association relation stored in the first binding cache module 21.

The second packet processing module 23 is adapted to receive the packet carrying the binding index option sent from the MN 1, search for a binding entry according to the CoA of the MN 1 in the packet, and obtain the HoA corresponding to the HoA index in the binding index option to substitute the CoA in the packet.

The HA 3 includes a second binding cache module 31 and a third packet processing module 32.

The second binding cache module 31 is adapted to perform binding update according to the BU message sent from the MN 1, so as to bind the HoA, the HoA index, and the CoA.

The third packet processing module 32 is adapted to receive the packet carrying the binding index option sent from the MN 1, search for a binding entry according to the CoA of the MN 1 in the packet, and obtain the HoA corresponding to the HoA index in the binding index option to substitute the CoA in the packet.

The system of this embodiment may employ the communication method provided in the first embodiment.

In a fifth embodiment, a system for communication in mobile IPv6 networks is further provided. The physical structure of this embodiment is substantially the same as that of the fourth embodiment, but the difference there-between lies in that, in the system of this embodiment, a binding index extension header is adopted to carry the HoA index in a packet transmitted between the entities. In this embodiment, the system includes an MN, a CN, and an HA.

The MN includes a BU module serving as an index association module, a first packet sending module, and a first packet processing module.

The BU module is adapted to send a BU message containing an HoA and an HoA index corresponding to the HoA to the HA and/or the CN, so as to notify the HA and/or the CN of an association relation between the HoA and HoA index of the MN.

The first packet sending module is adapted to remove an HoA option from a packet when the MN in a foreign link sends the packet to the CN or the HA, and then set a binding index extension header carrying the HoA index corresponding to the HoA of the MN in the packet according to the association relation in the BU module.

The first packet processing module is adapted to receive the packet carrying the binding index extension header from the CN, and obtain the HoA corresponding to the HoA index in the binding index extension header to substitute a CoA in the packet.

The CN includes a first binding cache module, a second packet sending module, and a second packet processing module.

The first binding cache module is adapted to perform binding update according to the BU message sent from the MN, so as to bind the HoA, the HoA index, and the CoA, and thus store the association relation between the HoA and the HoA index notified by the MN.

The second packet sending module is adapted to remove a Type-2 routing header from a packet when the CN sends the packet to the MN in a foreign link, and then set a binding index extension header carrying the HoA index corresponding to the HoA of the MN in the packet according to the association relation stored in the first binding cache module.

The second packet processing module is adapted to receive the packet carrying the binding index extension header from the MN, search for a binding entry according to the CoA of the MN in the packet, and obtain the HoA corresponding to the HoA index in the binding index extension header to substitute the CoA in the packet.

The HA includes a second binding cache module and a third packet processing module.

The second binding cache module is adapted to perform binding update according to the BU message from the MN, so as to bind the HoA, the HoA index, and the CoA.

The third packet processing module is adapted to receive the packet carrying the binding index extension header from the MN, search for a binding entry according to the CoA of the MN in the packet, and obtain the HoA corresponding to the HoA index in the binding index extension header to substitute the CoA in the packet.

The system of this embodiment may employ the communication method provided in the second or third embodiment.

To sum up, in the embodiments of the present invention, an HoA index option or a binding index extension header carrying an HoA index is adopted to substitute an HoA option and a Type-2 routing header in a communication packet. As the HoA index is usually a simple pointer, the occupied space of the header is greatly reduced. Meanwhile, the HoA index is simple in content and is not relevant to any privacy parameter in content, thus ensuring the security of communication. Furthermore, even if a plurality of HoAs of the MN is bound to the same CoA, it does not cause any confusion. In addition, according to the embodiments of the present invention, a BU message is employed to notify the association relation between the HoA and the HoA index, so that the notification process has a higher security and is easily implemented.

In view of the above, the BU method and the method and system for communication in mobile IPv6 networks have been described in detail. The principle and implementation of the present invention are illustrated with exemplary embodiments. However, the above embodiments are only intended to explain the method and key points of the present invention, instead of limiting the scope of the present invention. It will be apparent to those skilled in the art that various modifications and variations can be made to the structure of the present invention without departing from the scope or spirit of the invention. Therefore, the content of the specification is not intended to limit the scope of the present invention.

What is claimed is:

1. A mobile node (MN) in a system for communication in mobile IPv6 networks, comprising:
a binding update (BU) module, adapted to send a BU message to a destination node, wherein the BU message comprises an home address (HoA) and an HoA index corresponding to the HoA; and
a first packet sending module, adapted to send a packet to the destination node, wherein when the MN is in a foreign link, the module carries the HoA index corresponding to the HoA in the packet to be sent, and removes the HoA from the packet.

2. The MN according to claim 1, further comprising: a first packet processing module, adapted to receive the packet carrying the HoA index and obtain the HoA corresponding to the HoA index.

3. The MN according to claim 1, wherein a mobility header of the packet carrying the HoA index comprises a binding index option for carrying the HoA index; or
the packet carrying the HoA index comprises a binding index extension header for carrying the HoA index.

4. A method for communication in mobile IPv6 networks, comprising:
notifying a destination node in communication of an association relation between a home address (HoA) and an HoA index of a mobile node (MN); and
carrying the HoA index in an interactive packet between the MN and the destination node, and then obtaining, by the MN or the destination node as a receiving end of the packet, the HoA through the HoA index.

5. The method for communication in mobile IPv6 networks according to claim 4, wherein when the MN is in a foreign link, the interactive packet further comprises a care of address (CoA) of the MN; and
the obtaining, by the destination node as the receiving end of the packet, the HoA through the HoA index further comprises: receiving, by the destination node, the packet carrying the HoA index, and searching for the HoA corresponding to the HoA index according to the CoA of the MN in the packet.

6. The method for communication in mobile IPv6 networks according to claim 4, wherein the notifying the destination node of the association relation between the HoA and HoA index of the MN further comprises:
sending, by the MN, a binding update (BU) message to the destination node, wherein the BU message comprises the HoA, HoA index corresponding to the HoA, and a care of address (CoA) of the MN; and
performing, by the destination node, binding update according to the BU message, so as to bind the HoA, HoA index, and the CoA.

7. The method for communication in mobile IPv6 networks according to claim 6, wherein the HoA index is a location mark or an array subscript of each HoA in an HoA list stored in the MN.

8. The method for communication in mobile IPv6 networks according to claim 4, wherein the carrying the HoA index in the interactive packet further comprises: setting a binding index option carrying the HoA index corresponding to the HoA of the MN in a mobility header of the interactive packet; or
setting a binding index extension header carrying the HoA index corresponding to the HoA of the MN in the interactive packet.

9. The method for communication in mobile IPv6 networks according to claim 4, wherein the destination node comprises a communication node (CN) or a home agent (HA).

10. A communication node (CN) in a system for communication in mobile IPv6 networks, comprising:
a first association storage module, adapted to receive and store an association relation between an HoA and an HoA index notified by a mobile node (MN); and
a second packet sending module, adapted to send a packet, wherein when sending a packet to the MN located at a foreign link, the module carries the HoA index corresponding to the HoA of the MN in the packet, and removes the HoA from the packet.

11. The CN according to claim 10, further comprising: a second packet processing module, adapted to receive the packet carrying the HoA index and obtain the HoA corresponding to the HoA index.

12. The CN according to claim 10, wherein the first association storage module further comprises a first binding cache module adapted to receive a binding update (BU) message from the MN, so as to bind the HoA, the HoA index, and a CoA in the BU message.

13. The CN according to any one of claims 10, wherein a mobility header of the packet carrying the HoA index further comprises a binding index option for carrying the HoA index; or
the packet carrying the HoA index further comprises a binding index extension header for carrying the HoA index.

14. A home agent (HA) in a system for communication in mobile IPv6 networks, comprising:
a second association storage module, adapted to store an association relation between an home address (HoA) and an HoA index notified by a mobile node (MN); and
a third packet processing module, adapted to receive a packet carrying the HoA index, and obtain the HoA corresponding to the HoA index.

15. The HA according to claim 14, wherein the second association storage module further comprises a second binding cache module adapted to receive a binding update (BU) message from the MN, so as to bind the HoA, the HoA index, and a CoA in the BU message.

16. A system for communication in mobile IPv6 networks, comprising:
a mobile node (MN), adapted to notify a destination node of an association relation between an home address (HoA) and an HoA index thereof, wherein when the MN is in a foreign link, the HoA index corresponding to the HoA is carried in a packet to be sent; and
a destination node, adapted to receive and store the association relation between the HoA and the HoA index of the MN, receive the packet carrying the HoA index, and obtain the corresponding HoA according to the HoA index.

17. The system for communication in mobile IPv6 networks according to claim 16, wherein the destination node is a communication node (CN), and the CN carries the HoA index corresponding to the HoA of the MN in a packet when sending the packet to the MN located at a foreign link.

18. The system for communication in mobile IPv6 networks according to claim 16, wherein the destination node is a home agent (HA).
